(19) United States
(12) Patent Application Publication
(10) Pub. No.: US 2014/0230051 A1
(43) Pub. Date: Aug. 14, 2014

(54) FRAUD DETECTION FOR IDENTITY MANAGEMENT SYSTEMS

(71) Applicant: APPLE INC., Cupertino, CA (US)

(72) Inventors: Saravanan Vallinayagam, San Ramon, CA (US); Gunaranjan Chandraraju, Sunnyvale, CA (US); Selvarajan Subramaniam, Cupertino, CA (US); Lon S. Hardeman, Foster City, CA (US); Vinamra Agarwal, San Jose, CA (US); Hai-Tao Li, San Ramon, CA (US); Umesh Batra, Cupertino, CA (US); Prabhakaran Vaidyanathaswami, San Jose, CA (US)

(73) Assignee: Apple Inc., Cupertino, CA (US)

(21) Appl. No.: 13/763,553

(22) Filed: Feb. 8, 2013

(51) Int. Cl. H04L 29/06

(52) U.S. Cl. CPC H04L 63/1416
USPC 726/22

(57) ABSTRACT

Systems, methods and computer program products for identifying and remediating in real-time (or near real-time) fraudulent activities associated with identity management systems are disclosed. An event (e.g., client request to logon to an account) is received during a time interval. An abnormal pattern in one or more characteristics of the event is determined. The event is associated with a client identity. One or more reputation scores for the client identity are determined based on event history data associated with the client identity. One or more state objects for one or more client identifier attributes are updated with the reputation scores. One or more remedial actions are implemented against the client request using the one or more updated state objects.

### TECHNICAL FIELD

This disclosure is related generally to identity management systems.

### BACKGROUND

An Internet-facing identity management system is vulnerable to a variety of attacks, including account take over, fraudulent activities, creation of fraudulent accounts and denial of service attacks. As hackers and fraudsters are getting better and more sophisticated in online transaction attacks, there is a need to detect and remediate fraud in real-time to protect consumers and businesses.

### SUMMARY

Systems, methods and computer program products for identifying and remediating in real-time fraudulent activities associated with identity management systems are disclosed. An event (e.g., client request to logon to an account) is received during a time interval. An abnormal pattern in characteristics of one or more attributes of the event is determined. The event is associated with a client identity. One or more reputation scores for the client identity are determined based on event history data associated with the client identity. One or more state objects for one or more client identifier attributes are updated with the reputation scores. One or more remedial actions are implemented against the client request using the one or more updated state objects.

Other implementations are directed to systems, computer program products and computer-readable mediums.

Particular implementations disclosed herein provide one or more of the following advantages. A decision on whether to take remedial action against a client request is improved by determining a reputation of a client identity associated with the client request based on historical event data associated with the client identity. The reputation may be used to detect potential fraudulent activity in real-time or near real-time and to implement an appropriate remedial action against the client request.

The details of the disclosed implementations are set forth in the accompanying drawings and the description below. Other features, objects, and advantages will be apparent from the description and drawings, and from the claims.

### DESCRIPTION OF DRAWINGS

FIG. 1 is a block diagram of an exemplary fraud detection system for identity management systems.

FIG. 2 is a block diagram of an exemplary centralized account fraud engine for identity management systems.

FIG. 3 is a block diagram of an exemplary identity management event processing services module for an identity management system.

FIG. 4 is a block diagram of an exemplary real-time traffic validation services module for identity management systems.

FIG. 5 is a flow diagram of an exemplary process of fraud detection.

FIG. 6 is a block diagram of exemplary computer system architecture for implementing fraud detection.

The same reference symbol used in various drawings indicates like elements.

### DETAILED DESCRIPTION

### Exemplary Fraud Detection System

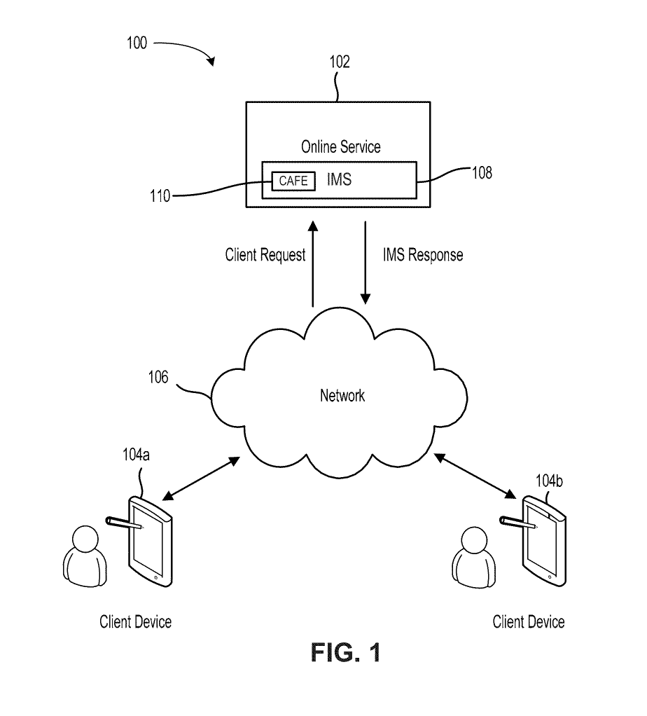

FIG. 1 is a block diagram of an exemplary fraud detection system 100 for identity management systems. In some implementations, fraud detection system 100 may include online service 102, identity management system 108 (IMS), centralized account fraud engine (CAFE) 110 and client devices 104. Online service 102 and client devices 104 communicate through network 106 (e.g., the Internet).

Online service 102 may be any service that requires users to have a user account. Some examples of online service 102 are online stores for purchasing and downloading digital content, such as music, videos, books and software applications.

Client devices 104 can be any device capable of connecting to online service 102 through network 106. Some examples of client devices 104 are personal computers, smart phones and electronic tablets.

During operation, IMS 108 receives requests from client devices 104 to access online service 102. The request may require that the user of client device 104 provide login information, such as a username and password. This request is also referred to as an “event.” When IMS 108 detects a real-time event (e.g., a user login event), IMS 108 submits a fraud processing request to CAFE 110. Based on the results of the fraud processing, IMS 108 may send a response to client device 104 to accept or deny the request.

CAFE 110 is a centralized real-time or near real-time system for identifying and remediating fraudulent events for IMS 108. CAFE 110 identifies fraudulent network events based on a combination of processes applied to attributes. Some examples of attributes may include but are not limited to: network signatures, device signatures, client account information, remediation history of client identity, event history of the client identity, external intelligence collected on the client identity (e.g., black lists, white lists, scores), request velocity from a client source or any other information that can be used by CAFE 110 to detect patterns of fraudulent activities.

Some examples of network and device signatures may include but are not limited to: user identifier (ID), device ID, client Internet Protocol (IP) address, device IP address, proxy IP address, user-agent header, timestamp, geo-location, language, requesting services or any other information that may be used by CAFE 110 to identify a client identity or event.

The remediation of fraudulent events by CAFE 110 may include combinations of the following remedial actions: deny client request, slowdown response time to the client request, enforce additional security protocols on the client request or the attacked resource (e.g., an online account) or any other desired remedial action.

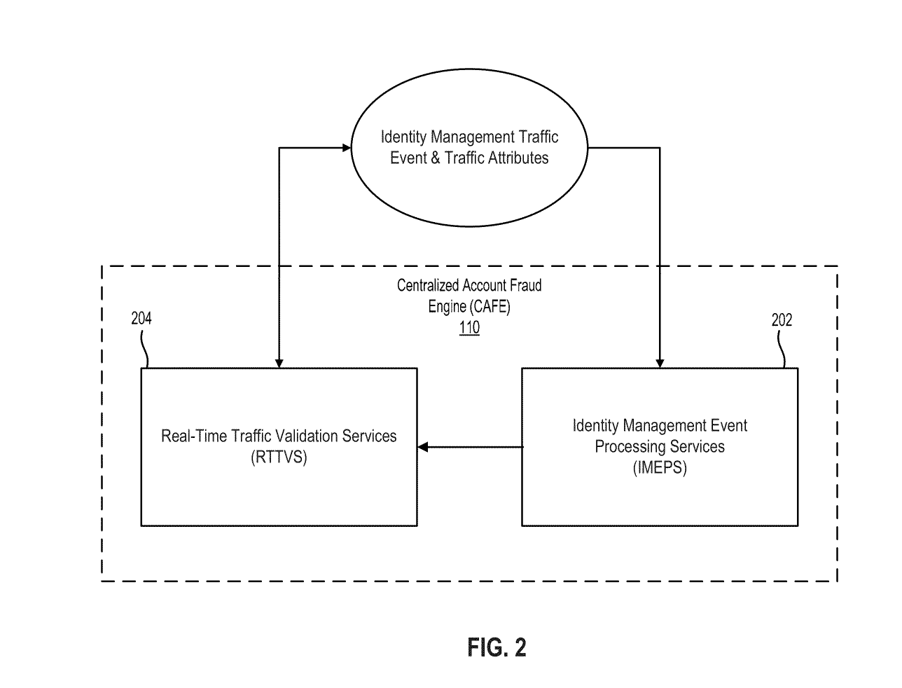

FIG. 2 is a block diagram of an exemplary CAFE 110 for IMS 108. In some implementations, CAFE 110 may include identity management event processing services 202 (IMEPS) and real-time traffic validation services 204 (RTTVS). IMEPS 202 and RTTVS 204 can be implemented in software, hardware or a combination of both.

In some implementations, IMEPS 202 may receive an event (e.g., a client request) in real-time or near real-time from IMS 108. The event includes attributes contained in, for example, HTTP headers, user-agent headers, cookies, session data, timestamp, velocity data, etc. A client identity can be established by IMEPS 202 using one or more of the attributes, such as a client IP address or user-agent header, etc. In some implementations, IMEPS 202 analyzes the attributes using a statistical process (e.g., a Markov chain) to identify abnormal patterns in one or more characteristics of the event. A Markov chain is a sequence of random variables, X₁, X₂, X₃, . . . with the Markov property, given by

Pr(Xₙ₊₁=x|X₁=x_{1,} X₂=x₂, . . . , Xₙ=xₙ)=Pr(Xₙ₊₁=x|Xₙ=xₙ).

The possible values of Xᵢ form a countable set S called the state space of the chain.

An event may be considered abnormal if a threshold number of its characteristics are determined to be abnormal, relative to other event characteristics received during a time interval. An example event is a user logging into her account. When the processing by IMEPS 202 is finished, the result of the analysis is sent to RTTVS 204 for further processing. Event data associated with logins to an application or service can be stored in a database and can be indexed using a suitable query mechanism. In this example, historical data for login events can be used to determine state transition probabilities for a Markov chain model. A current login event by a client identity can be run through the Markov chain model to determine if the login event is normal or abnormal. In this example, the random variable X in the Markov chain model can be a vector of login event attributes associated with login events.

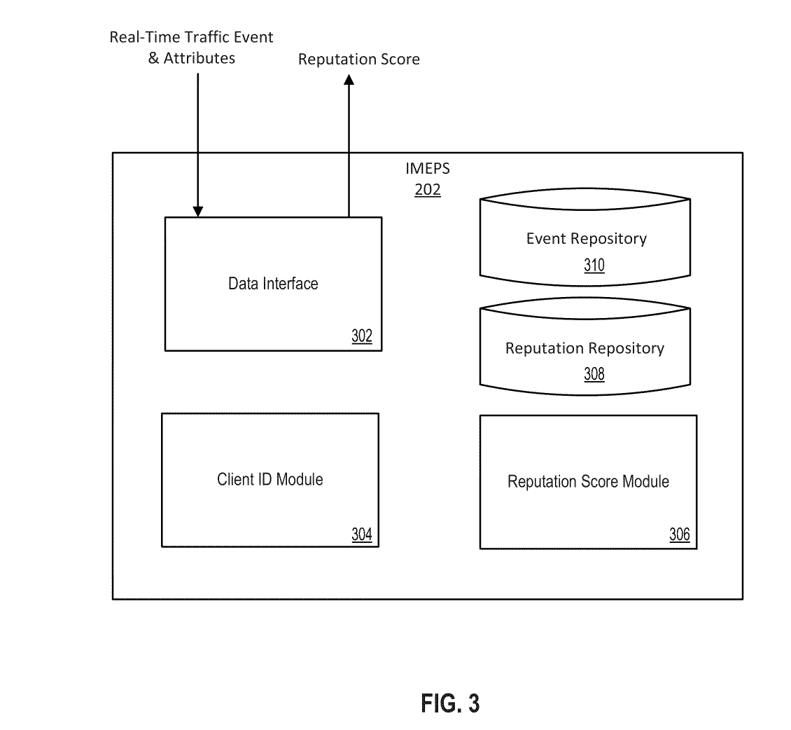

FIG. 3 is a block diagram of an exemplary IMEPS 202 for IMS 108. In some implementations, IMEPS 202 may include data interface 302, client ID module 304, reputation score module 306, reputation repository 308 and event repository 310.

In some implementations, the event is received by IMEPS 202 through data interface 302, which communicates with IMS 108. Client ID module 304 uses the attributes to determine a client identity, such as the client IP address or user agent header. Reputation score module 306 computes a reputation score for the client identity based on historical event data for the client identity, which is stored in event repository 310. The reputation scores are stored in reputation repository 308. In some implementations, reputation scores maybe generated for each attribute that identifies the client, which is hereafter also referred to as “client identifiers.” A reputation score may be generated for each client identifier associated with the event. Client identifiers may include but are not limited to a client IP address, user ID, device, ID, phone number. The reputation score indicates a level of abnormality associated with the client identifier. In some implementations, the score may be stored in repository 308 as a state object. The state objects for the client identifiers may be updated over time using new reputation scores generated for subsequent events.

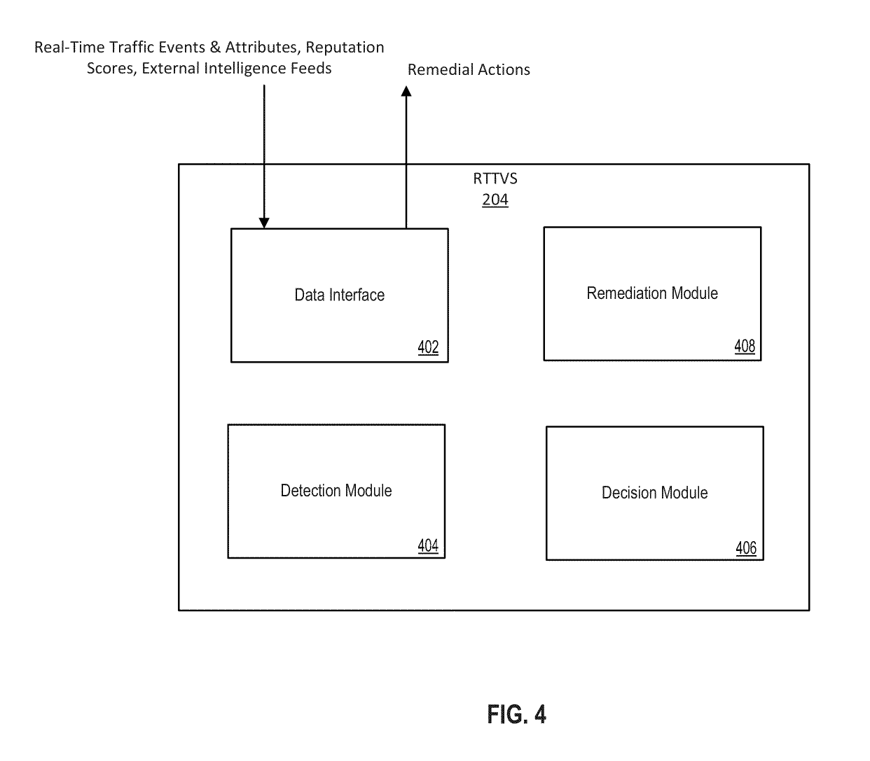

The reputation score is sent through data interface 302 to RTTVS 204 for further use in fraud decision making and the selection of remedial actions based on the decision, as described in reference to FIG. 4.

FIG. 4 is a block diagram of an exemplary RTTVS 204 for IMS 108. In some implementations, RTTVS 204 may include data interface 402, detection module 404, decision module 406 and remediation module 408.

RTTVS 204 receives the event and reputation score from IMEPS 202. RTTVS 204 may also receive or have access to external intelligence feeds. Detection module 404 uses the reputation score and/or external intelligence feeds (if available) to determine if a fraudulent event has occurred. External intelligence feeds may include any available intelligence associated with the client identity, including but not limited to black lists, white lists and any other information received from sources other than the CAFE 110. Such external sources may include, for example, payment systems for online sales transactions or government agencies.

If fraud is detected, decision module 406 determines a course of remedial actions to be taken against the client identity over time. The actions determined by decision module 406 may be based on an algorithmic distribution of an acceptable range of remedial actions, which may lead to fraud prevention over time. The remedial actions may be implemented by remediation module 408. The remediation actions determined by decision module 406 over time may not seem as apparent “fraud prevention” actions to the source of the requests. Remedial actions can include but are not limited to: denying the request, slowing-down a response time to the request, triggering more security protocols (e.g., secondary authentication procedures), a false positive response to confuse hackers and any other suitable remedial actions. The remedial action and decisions can be stored in a repository and used by CAFE 110 to improve future decisions through self-learning.

### Exemplary Process

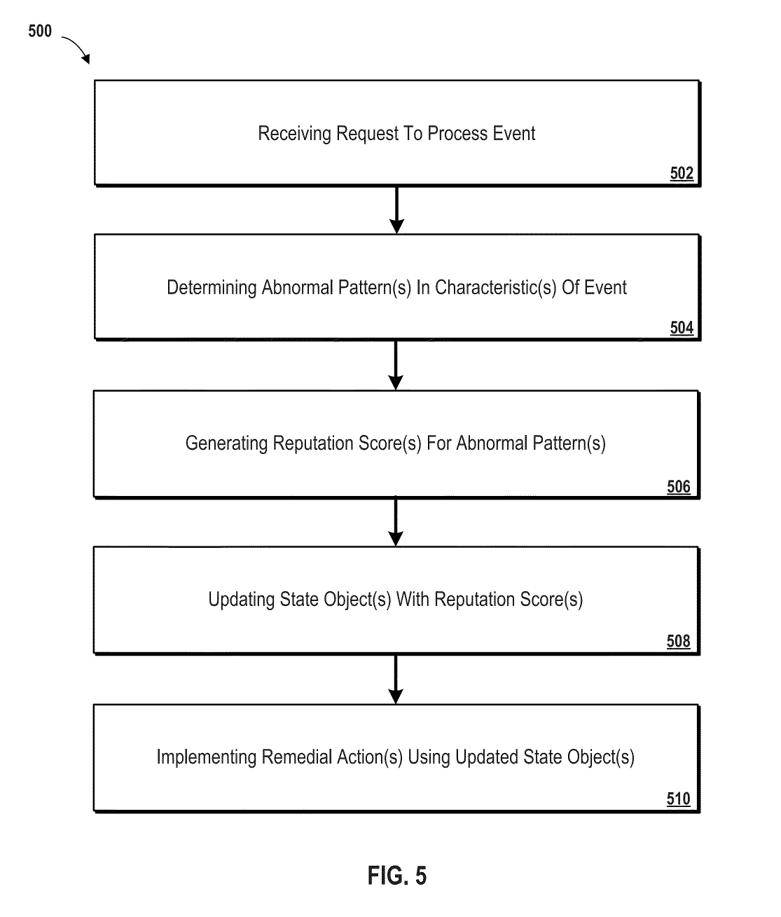

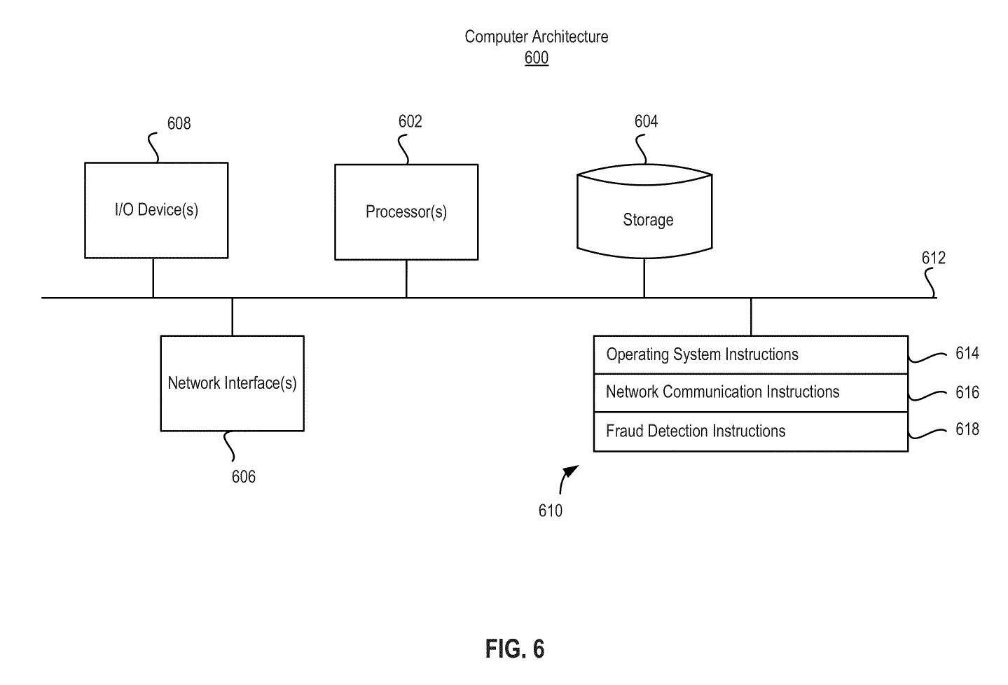

FIG. 5 is a flow diagram of an exemplary process 500 of fraud detection. Process 500 may be implemented on computer system architecture 600, as described in reference to FIG. 6.

In some implementations, process 500 may begin when a centralized account fraud detection engine receives a request to process an event (502). The request may be sent by an identity management system. An example event is a user attempting to log into her account for an online resource.

Process 500 may continue by determining one or more abnormal patterns in one or more characteristics of the event (504). Abnormal patterns in one or more characteristics of the event may be determined by analyzing one or more attributes associated with the event. Characteristics of an event may be determined to be abnormal using a statistical process. An example statistical process is a Markov chain. An event may be considered abnormal if a threshold number of characteristics associated with the event are determined to be abnormal relative to other event characteristics received during a time interval.

Process 500 may continue by generating one or more reputation scores for abnormal patterns (506). For example, reputation scores may be determined from a history of client identifier attributes (e.g., client IP address, user ID, device ID, phone number) and/or external intelligence (e.g., black lists, white lists, scores). A reputation score may indicate a level of abnormality with its associated client identifier attribute. An example of external intelligence is a “black list” that may include client identities associated with fraudulent events.

Process 500 may continue by updating one or more state objects for the one or more client identifiers with the one or more reputation scores (508).

Process 500 may continue by implementing one or more remedial actions using the one or more updated state objects (510). Some examples of remedial actions may include denying the request, slowing down the response time for processing the request, initiating additional security protocols or procedures, providing false positives to thwart hackers or any other suitable remedial action.

### Exemplary Computer System Architecture

FIG. 6 is a block diagram of exemplary computer system architecture 600 for implementing fraud detection. Architecture 600 may be implemented on any data processing apparatus that runs software applications derived from instructions, including without limitation personal computers, smart phones, electronic tablets, game consoles, servers or mainframe computers. In some implementations, the architecture 600 may include processor(s) 602, storage device(s) 604, network interfaces 606, Input/Output (I/O) devices 608 and computer-readable medium 610 (e.g., memory). Each of these components may be coupled by one or more communication channels 612.

Communication channels 612 may be any known internal or external bus technology, including but not limited to ISA, EISA, PCI, PCI Express, NuBus, USB, Serial ATA or FireWire.

Storage device(s) 604 may be any medium that participates in providing instructions to processor(s) 602 for execution, including without limitation, non-volatile storage media (e.g., optical disks, magnetic disks, flash drives, etc.) or volatile media (e.g., SDRAM, ROM, etc.). Storage devices 604 may be used to store the repositories 308, 310, as described in reference to FIG. 3.

I/O devices 608 may include displays (e.g., touch sensitive displays), keyboards, control devices (e.g., mouse, buttons, scroll wheel), loud speakers, audio jack for headphones, microphones and another device that may be used to input or output information.

Computer-readable medium 610 may include various instructions 614 for implementing an operating system (e.g., Mac OS®, Windows®, Linux). The operating system may be multi-user, multiprocessing, multitasking, multithreading, real-time and the like. The operating system performs basic tasks, including but not limited to: keeping track of files and directories on storage devices(s) 604; controlling peripheral devices, which may be controlled directly or through an I/O controller; and managing traffic on communication channels 612.

Network communications instructions 616 may establish and maintain network connections with client devices (e.g., software for implementing transport protocols, such as TCP/IP, RTSP, MMS, ADTS, HTTP Live Streaming).

Computer-readable medium 610 may store instructions 618, which, when executed by processor(s) 602 implement the features and processes of CAFE 110, described in reference to FIGS. 1-5.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). For example, the data access daemon may be accessed by another application (e.g., a notes application) using an API. An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving a request to process an event during a time interval;
determining an abnormal pattern in one or more characteristics of the event;
determining a reputation score of a client identity associated with the event based on event history associated with the client identity;
updating a state object with the reputation score; and
implementing a remedial action using the updated state object, where the method is performed by one or more hardware processors.

2. The method of claim 1, where determining an abnormal pattern in one or more characteristics of the event, further comprises:
analyzing the attributes using a Markov chain model.

3. The method of claim 1, where determining an abnormal pattern in one or more characteristics of the event, further comprises:
determining that a threshold number of the attributes are determined to be abnormal relative to other attributes received during the time interval.

4. The method of claim 1, where the event is a client request to log into an account.

5. The method of claim 1, where determining a reputation score of the client identity based on event history, further comprises:
generating a score for the client identity that indicates a level of abnormality.

6. The method of claim 4, wherein implementing a remedial action using the updated state object includes denying the client request.

7. The method of claim 4, wherein implementing a remedial action using the updated state object includes requiring authentication of a user associated with the client request.

8. The method of claim 4, wherein implementing a remedial action using the updated state object includes resetting a password associated with the account.

9. The method of claim 4, wherein implementing a remedial action using the updated state object includes generating an alert or notification.

10. The method of claim 4, wherein implementing a remedial action using the updated state object includes adding the client identity to a list of client identities associated with fraudulent events.

11. A system comprising:
one or more processors;
memory coupled to the one or more processors and configured to store instructions, which, when executed by the one or more processors, causes the one or more processors to perform operations comprising:
receiving a request to process an event during a time interval;
determining an abnormal pattern in one or more characteristics of the event;
determining a reputation score of a client identity associated with the event based on event history associated with the client identity;
updating a state object with the reputation score; and
implementing a remedial action using the updated state object.

12. The system of claim 11, where determining an abnormal pattern in one or more characteristics of the event, further comprises:
analyzing the attributes using a Markov chain model.

13. The system of claim 11, where determining an abnormal pattern in one or more characteristics of the event, further comprises:
determining that a threshold number of the attributes are determined to be abnormal relative to other attributes received during the time interval.

14. The system of claim 11, where the event is a client request to log into an account.

15. The system of claim 11, where determining a reputation of the client identity based on the client request history, further comprises:
generating a score for the client identity that indicates a level of abnormality.

16. The system of claim 14, wherein implementing a remedial action using the updated state object includes denying the client request.

17. The system of claim 14, wherein implementing a remedial action using the updated state object includes requiring authentication of a user associated with the client request.

18. The system of claim 14, wherein implementing a remedial action using the updated state object includes resetting a password associated with the account.

19. The system of claim 14, wherein implementing a remedial action using the updated state object includes generating an alert or notification.

20. The system of claim 14, wherein implementing a remedial action against using the updated state object includes adding the client identity to a list of client identities associated with fraudulent events.
